(19) United States
(12) Patent Application Publication
(10) Pub. No.: US 2021/0164410 A1
(43) Pub. Date: Jun. 3, 2021

(54) Fuel Injection Control Device and Fuel Injection Control Method for Internal Combustion Engine

(71) Applicant: Hitachi Automotive Systems, Ltd., Hitachinaka-shi, Ibaraki (JP)

(72) Inventors: Yoshitatsu NAKAMURA, Hitachinaka-shi (JP); Atsushi MURAI, Hitachinaka-shi (JP); Kohsuke KANDA, Hitachinaka-shi (JP)

(21) Appl. No.: 17/048,143

(22) PCT Filed: Mar. 12, 2019
(86) PCT No.: PCT/JP2019/009944

§ 371 Date: Oct. 16, 2020

(30) Foreign Application Priority Data
Apr. 19, 2018 (JP) 2018-080571

(51) Int. Cl. F02D 41/06; F02D 29/02; F02M 25/06

(52) U.S. Cl. CPC F02D 41/062; F02M 25/06; F02D 29/02

(57) ABSTRACT

A fuel injection control device and a fuel injection control method according to the present invention are applied to an internal combustion engine including a blow-by gas recirculation device configured to return blow-by gas into an intake passage. According to the present invention, a dilution ratio which indicates how much lubricating oil of the internal combustion engine is diluted with unburned fuel mixed in the lubricating oil is determined. Then, fuel reduction control for reducing fuel supply to the internal combustion engine by a subtractive fuel amount depending on the dilution ratio is performed in a period from an onset of start-up of the internal combustion engine to when a number of combustion cycles accumulated from the onset of the engine start-up reaches a threshold value.

### TECHNICAL FIELD

The present invention relates to a fuel injection control device and to a fuel injection control method for an internal combustion engine.

### BACKGROUND ART

Patent Document 1 discloses a fuel injection amount control device for an internal combustion engine including a blow-by gas recirculation device. In such an internal combustion engine, unburned fuel tends to leak into the crankcase and to be mixed into the lubricating oil during vertical reciprocating movement of pistons, and a vaporized portion of such unburned fuel from the lubricating oil is returned to the intake system. The fuel injection amount control device disclosed in Patent Document 1 determines an additional fuel amount to be added to the base fuel injection amount during engine start-up by taking into account the amount of fuel remaining in the intake system, which corresponds to the amount of unburned fuel that has been vaporized from the lubricating oil in a period from the end of the previous engine operation to the start of the current engine operation. Furthermore, for a predetermined period of time after the onset of the engine start-up, the above fuel injection amount control device changes the additional fuel amount to a corrected value based on the parameters (the dilution ratio of lubricating oil to fuel, the cooling water temperature at the start of the current engine operation, and the lubricating oil temperature at the end of the previous engine operation) that will significantly affect the amount of fuel remaining in the intake system.

### REFERENCE DOCUMENT LIST

### Patent Document

Patent Document 1: JP 2008-223616 A

### SUMMARY OF THE INVENTION

### Problem to be Solved by the Invention

In such an internal combustion engine, an excessive rich shift of the air-fuel ratio may be caused by fuel remaining in the intake passages at the engine start-up, and a fuel reduction control is performed to prevent such an excessive rich shift. However, if the fuel supply is excessively reduced by the fuel reduction control, the air-fuel ratio may excessively shift to the lean side, and this may cause poor starting performance and/or detrimental exhaust characteristics during the engine start-up. For example, if the fuel reduction control is performed throughout the entire period from the onset to the completion of the engine start-up, downward fuel correction as described above may continue even after the fuel remaining in the intake passages is completely scavenged away. As a result, the air-fuel ratio after the completion of the scavenging may excessively shift to the lean side, and may cause poor starting performance and/or detrimental exhaust characteristics during the engine start-up.

The present invention has been made in view of such conventional circumstances, and an object of the present invention is to provide a fuel injection control device and a fuel injection control method for an internal combustion engine including a blow-by gas recirculation device configured to return blow-by gas into an intake passage, which device and method enable fuel reduction control for reducing the fuel supply so as to prevent an excessive rich shift of the air-fuel ratio during the engine start-up in a well-balanced manner so that excessive fuel reduction is avoided.

### Means for Solving the Problem

To this end, according to an aspect of the present invention, a fuel injection control device for an internal combustion engine including a blow-by gas recirculation device configured to return blow-by gas into an intake passage is configured to: determine a dilution ratio which indicates how much lubricating oil of the internal combustion engine is diluted with unburned fuel mixed in the lubricating oil; and perform fuel reduction control for reducing fuel supply to the internal combustion engine by a subtractive fuel amount depending on the dilution ratio, in a period from an onset of start-up of the internal combustion engine to when a number of combustion cycles accumulated from the onset of the engine start-up reaches a threshold value.

Furthermore, according to another aspect of the present invention, a fuel injection control method for an internal combustion engine including a blow-by gas recirculation device configured to return blow-by gas into an intake passage includes: determining a dilution ratio which indicates how much lubricating oil of the internal combustion engine is diluted with unburned fuel mixed in the lubricating oil; determining, based on the dilution ratio, an initial value of a downward correction ratio for correcting fuel supply to the internal combustion engine; gradually decreasing the downward correction ratio from the initial value as a number of combustion cycles accumulated from an onset of start-up of the internal combustion engine increases; and reducing the fuel supply to the internal combustion engine based on the downward correction ratio in a period from the onset of start-up of the internal combustion engine to when the accumulated number of combustion cycles reaches a threshold value.

### Effects of the Invention

According to the present invention as described above, it is possible to prevent excessive reduction of fuel supply during the start-up of the internal combustion engine, and thus, to provide improved starting performance and/or improved exhaust characteristics during the start-up of the internal combustion engine.

### BRIEF DESCRIPTION OF THE DRAWINGS

FIG. 1 is a system diagram of an internal combustion engine according to a first embodiment of the present invention.

FIG. 2 is a view illustrating a cooling system for the internal combustion engine.

FIG. 3 is a flowchart illustrating a procedure of fuel reduction control performed in accordance with fuel remaining in intake passages.

FIG. 4 illustrates characteristics for establishing the initial value of a downward correction ratio RQ to be applied when the cooling water is circulated during the previous engine stop.

FIG. 5 is a time series chart illustrating how the cooling water temperature and the lubricating oil temperature change during idle reduction.

FIG. 6 is a graph illustrating correlation between a reduction ratio RR and the accumulated number CIN of combustion cycles.

FIG. 7 illustrates characteristics for establishing the initial value of the downward correction ratio RQ to be applied when the cooling water is not circulated during the previous engine stop.

FIG. 8 is a graph illustrating a correction error due to the deviation of the cooling water temperature from the lubricating oil temperature.

FIG. 9 is a time series chart illustrating correlation between change in engine-remaining fuel level and a subtractive fuel amount.

FIG. 10 is a system diagram of an internal combustion engine according to a second embodiment of the present invention.

FIG. 11 is a flowchart illustrating a procedure of fuel reduction control according to the second embodiment.

FIG. 12 illustrates characteristics for establishing the initial value of the downward correction ratio RQ according to the second embodiment.

### MODE FOR CARRYING OUT THE INVENTION

### First Embodiment

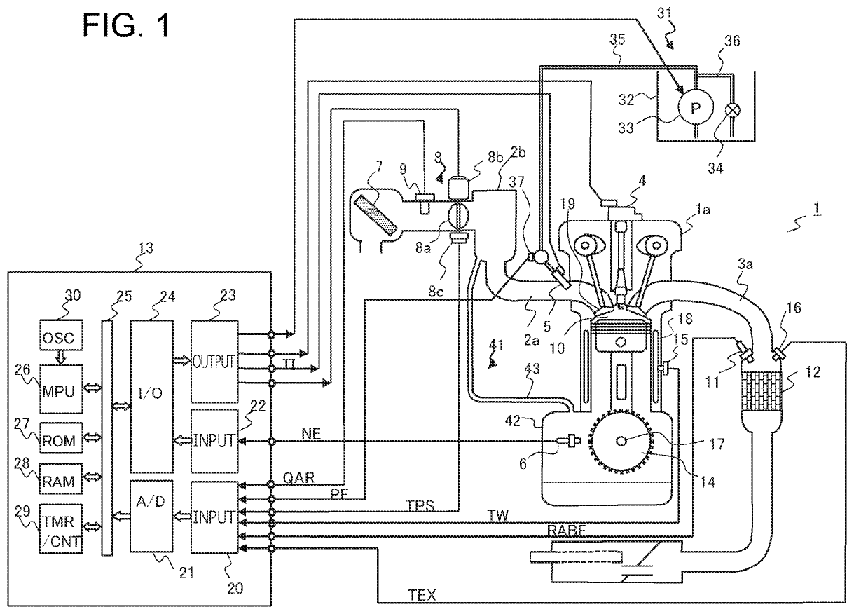

Hereinafter, a first embodiment of the present invention will be described. FIG. 1 illustrates an example of an internal combustion engine to which a fuel injection control device and a fuel injection control method according to the present invention are applied. An internal combustion engine 1 shown in FIG. 1 is a spark-ignition gasoline engine for vehicles. Internal combustion engine 1 has an engine body 1a including ignition devices 4 and fuel injection valves 5, etc.

Each fuel injection valve 5 is disposed in an intake pipe 2a and configured to inject fuel into intake pipe 2a, directing the fuel to or near the valve head of an intake valve 19. That is, internal combustion engine 1 shown in FIG. 1 is a so-called port-injection internal combustion engine, which is configured such that each fuel injection valve 5 injects fuel into intake pipe 2a. As an alternative, internal combustion engine 1 may be a so-called in-cylinder direct injection internal combustion engine, which is configured such that each fuel injection valve 5 directly injects fuel into a combustion chamber 10.

Intake air drawn in internal combustion engine 1 passes through an air cleaner 7 and then through a throttle valve 8a of an electronically controlled throttle 8 configured to control the flow rate of intake air. At the flow rate regulated by throttle valve 8a, the intake air is then drawn into combustion chambers 10 after being mixed with fuel injected into intake pipes 2a from fuel injection valves 5. Electronically controlled throttle 8 is configured to use a throttle motor 8b to open and close throttle valve 8a, and includes a throttle position sensor 8c configured to output a signal corresponding to a throttle position TPS, which indicates the degree of opening of throttle valve 8a.

A rotation speed sensing device 6 is configured to detect the teeth of a ring gear 14 and output, based on the detection, a signal indicating a rotation angle NE each time a crankshaft 17 rotates at a predetermined angle. A water temperature sensor 15 is configured to output a signal corresponding to the temperature (hereinafter “water temperature TW”) of cooling water circulated through a water jacket 18 in engine body 1a.

A flow rate sensing device 9 is disposed upstream of electronically controlled throttle 8 and is configured to output a signal corresponding to an intake air flow rate QAR of internal combustion engine 1. An exhaust emission control catalytic device 12 is disposed in an exhaust pipe 3a and is configured to reduce pollutants in exhaust gas from internal combustion engine 1.

An air-fuel ratio sensor 11 is disposed on exhaust pipe 3a at a position upstream of exhaust emission control catalytic device 12 and is configured to output a signal corresponding to an exhaust air-fuel ratio RABF. An exhaust temperature sensor 16 is disposed on exhaust pipe 3a at a position upstream of exhaust emission control catalytic device 12 and is configured to output a signal corresponding to an exhaust temperature TEX (° C.) at the inlet of exhaust emission control catalytic device 12.

A fuel supply device 31 is configured to supply fuel to fuel injection valves 5 at a predetermined fuel pressure. Fuel supply device 31 includes a fuel tank 32, an electric fuel pump 33, a pressure regulator 34, fuel supply piping 35, fuel return piping 36, and a fuel pressure sensor 37.

Fuel pump 33 draws fuel from fuel tank 32 and pumps the fuel to fuel injection valves 5 through fuel supply piping 35. Fuel return piping 36 is connected at one end to some midpoint of fuel supply piping 35 and is opened at the other end to fuel tank 32. In fuel return piping 36, pressure regulator 34 for returning fuel to fuel tank 32 through an orifice is disposed. The pressure (fuel pressure PF) of fuel supplied to fuel injection valves 5 is measured by fuel pressure sensor 37. Drive voltage for fuel pump 33 is controlled according to the fuel pressure PF measured by fuel pressure sensor 37, so that the pressure of fuel supplied to fuel injection valves 5 is adjusted to a target pressure.

An electronic control unit 13, which incorporates a microcomputer, receives the throttle position TPS, the intake air flow rate QAR, the rotation angle NE, the water temperature TW, the exhaust air-fuel ratio RABF, the exhaust temperature TEX, the fuel pressure PF, and other sensor measurement signals output from various sensors as described above. Based on the received sensor measurement signals, electronic control unit 13 calculates a fuel injection pulse width TI proportional to a fuel injection amount as well as injection timing therefor. Electronic control unit 13 has software-based functions to serve as a fuel injection control device for controlling fuel injection from fuel injection valves 5 by outputting, to each fuel injection valve 5, a valve open command signal corresponding to the fuel injection pulse width TI (ms) at the injection timing.

During the start-up of internal combustion engine 1, electronic control unit 13 controls fuel injection from fuel injection valves 5 using the fuel injection pulse width TI obtained by upwardly correcting a base fuel injection pulse width TP with an upward correction value Kst (TI=TP×Kst). The base fuel injection pulse width TP is proportional to a base fuel injection amount corresponding to a target air-fuel ratio. The upward correction value Kst (1.0≤Kst) is defined for use during the engine start-up. Electronic control unit 13 sets the upward correction value Kst to a greater value so as to further increase the amount of fuel injection as the water temperature TW at the start-up of internal combustion engine 1 decreases. This will improve the stability of combustion at the engine start-up, during which fuel injected from fuel injection valves 5 is less prone to atomization.

Furthermore, electronic control unit 13 outputs command signals also to ignition devices 4, electronically controlled throttle 8, and fuel pump 33, thereby controlling the ignition timing of each ignition device 4, the position (degree of opening) of throttle valve 8a, and the pressure of fuel supplied to each fuel injection valve 5 so as to control the operation of internal combustion engine 1. As components for receiving measurements output from various sensors and other data, and for outputting operation variables to various devices and other data, electronic control unit 13 includes an analog input circuit 20, an A/D converter circuit 21, a digital input circuit 22, an output circuit 23, and an I/O circuit 24.

In addition, as components for arithmetic data processing, electronic control unit 13 further includes a microcomputer including a microprocessor unit (MPU) 26, a read only memory (ROM) 27, and a random access memory (RAM) 28. Analog input circuit 20 receives the intake air flow rate QAR, the throttle position TPS, the exhaust air-fuel ratio RABF, the exhaust temperature TEX, the water temperature TW, the fuel pressure PF, and other sensor measurement signals. The various signals received by analog input circuit 20 are then passed to A/D converter circuit 21 and converted into digital signals therein. The resultant digital signals are output on a bus 25.

The signal indicating the rotation angle NE received by digital input circuit 22 is then output on bus 25 through I/O circuit 24. Bus 25 is connected to components such as MPU 26, ROM 27, RAM 28, and a timer/counter (TMR/CNT) 29. MPU 26, ROM 27, and RAM 28 exchange data with each other through bus 25.

A clock signal from a clock generator 30 is supplied to MPU 26. MPU 26 performs various arithmetic and operational processing in synchronization with the clock signal. ROM 27 includes, for example, an electronically erasable programmable read-only memory (EEPROM), which allows data stored therein to be erased and overwritten with different data. ROM 27 stores programs, determined data, initial values, etc. required for the operation of electronic control unit 13.

Any information stored by ROM 27 may be loaded into RAM 28 and MPU 26 through bus 25. RAM 28 is used as a work area for temporarily storing the results of the arithmetic and operational processing performed by MPU 26.

Timer/counter 29 is used to measure time and/or to keep counts of various events. The results of the arithmetic and operational processing performed by MPU 26 are output on bus 25 and then passed from output circuit 23 through I/O circuit 24 to ignition devices 4, fuel injection valves 5, electronically controlled throttle 8, fuel pump 33, etc.

Internal combustion engine 1 further includes a blow-by gas recirculation device 41. Blow-by gas refers to a mixture of exhaust gas and a vaporized portion of unburned fuel leaked from combustion chambers 10 into a crankcase 42, which contains lubricating oil, in internal combustion engine 1. Blow-by gas recirculation device 41 is configured to return blow-by gas into the intake system of internal combustion engine 1. Blow-by gas recirculation device 41 includes a blow-by gas recirculation passage 43 that communicatively connects the inside of crankcase 42 with the inside of an intake collector section 2b. Through blow-by gas recirculation passage 43, blow-by gas is returned from the inside of crankcase 42 into intake collector section 2b.

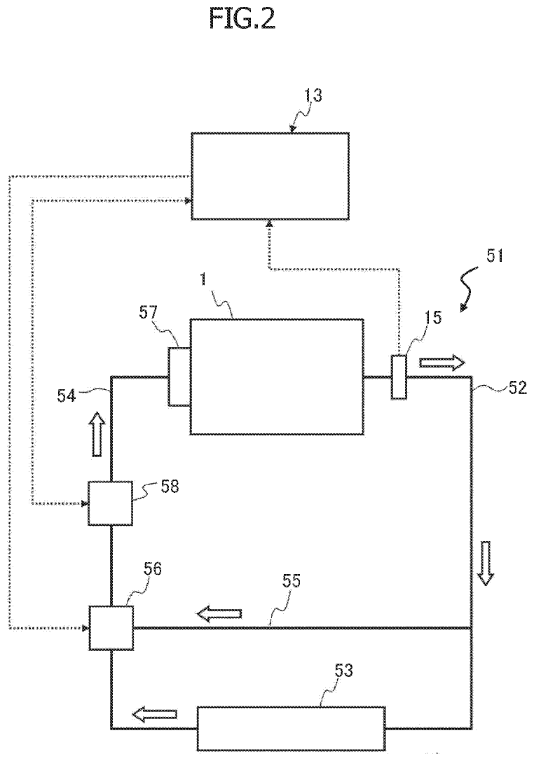

FIG. 2 illustrates an example of a cooling system 51 for internal combustion engine 1. Cooling water, which is a medium for cooling the cylinder block, cylinder head, etc. of internal combustion engine 1, is introduced to a radiator 53 through a first cooling water passage 52. The cooling water that has introduced into radiator 53 exchanges heat with external air and decreases in temperature as the cooling water passes through the radiator core. The cooling water that has passed through radiator 53 and sufficiently decreased in temperature returns to internal combustion engine 1 through a second cooling water passage 54.

To allow the cooling water discharged from internal combustion engine 1 to circulate through a route bypassing radiator 53, first cooling water passage 52 is communicatively connected to second cooling water passage 54 by a bypass passage 55. At the junction between second cooling water passage 54 and the downstream end of bypass passage 55, an electronically controlled thermostat 56 is disposed. Electronically controlled thermostat 56 is configured to open and close bypass passage 55 so as to stepwise or continuously change its cross-sectional opening between full open and full close. Electronically controlled thermostat 56 changes the ratio of cooling water that circulates through radiator 53 to cooling water that circulates bypassing radiator 53.

Between the downstream end of second cooling water passage 54 and electronically controlled thermostat 56, a mechanical water pump 57 and an electric water pump 58 for forcing the cooling water to circulate through internal combustion engine 1 and/or radiator 53 are disposed. Mechanical water pump 57 is mounted at the cooling water inlet of internal combustion engine 1, and driven by, for example, the camshaft of internal combustion engine 1.

Electric water pump 58 is driven by an electric motor, and is adapted to circulate the cooling water when internal combustion engine 1 stops. This allows the cooling performance and air heating function to be maintained even while internal combustion engine 1 is stopped by, for example, an idle reduction function. Electronically controlled thermostat 56 and electric water pump 58 are controlled by electronic control unit 13.

Cooling system 51 is not limited to the cooling system that includes the cooling water circuit shown in FIG. 2. For example, cooling system 51 may alternatively be a cooling system as disclosed in JP 2015-172355 A, which is capable of controlling the rate of cooling water flowing through the cylinder head and the rate of cooling water flowing through the cylinder block independently of each other. Alternatively, cooling system 51 may be a cooling system that does not include mechanical water pump 57 and uses electric water pump 58 to circulate the cooling water while internal combustion engine 1 is also in operation.

Here, when internal combustion engine 1 stops operation, fuel returned to the intake system by blow-by gas recirculation device 41 will remain in the intake passages between electronically controlled throttle 8 and intake valves 19. Such engine-remaining fuel flows into combustion chambers 10 together with fuel injected from fuel injection valves 5 at the subsequent restart of internal combustion engine 1. Here, as described above, in consideration of poor fuel atomization during engine start-up, the amount of fuel for injection is already increased according to the water temperature TW during the engine start-up. Thus, the addition of the fuel that has been returned by blow-by gas recirculation device 41 and remains in the intake system may increase the total fuel supply to an excessive level and may provide an excessively richer air-fuel ratio. This may lead to poor starting performance and/or detrimental exhaust characteristics during the start-up of internal combustion engine 1.

In view of the above, electronic control unit 13 reduces the additional fuel amount defined by the upward correction value Kst, and thus reduces the fuel supply to internal combustion engine 1, in consideration of the fuel returned by blow-by gas recirculation device 41 and remaining in the intake system while internal combustion engine 1 stops. Such control will be referred to as “fuel reduction control” herein. Now, the fuel reduction control will be described in detail. As described above, the fuel reduction control is performed during engine start-up so as to reduce the additional fuel amount in accordance with fuel that has been returned by blow-by gas recirculation device 41 and remains in the intake system during the previous stop of internal combustion engine 1. In other words, the fuel reduction control is performed based on engine-remaining fuel.

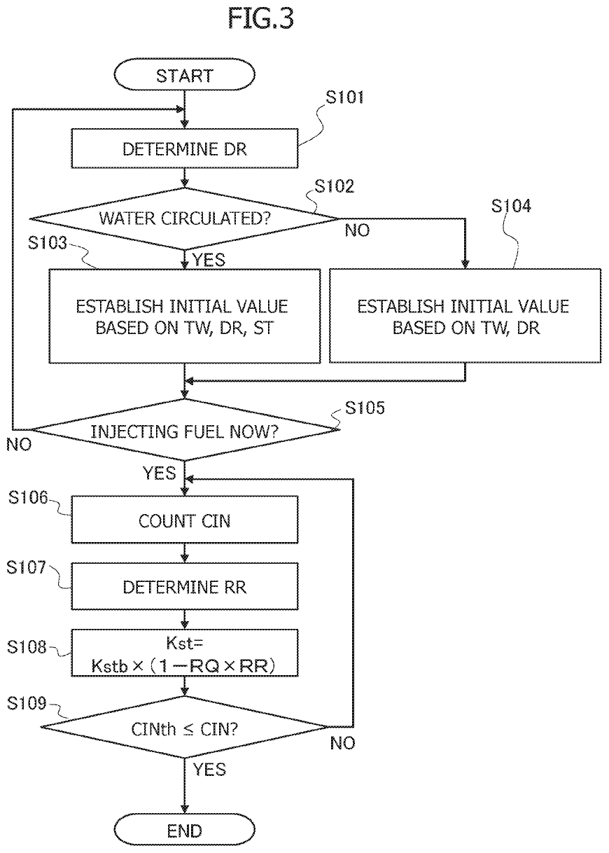

FIG. 3 is a flowchart illustrating a procedure example of the fuel reduction control performed by electronic control unit 13. First, electronic control unit 13 determines a lubricating oil dilution ratio DR in step S101. The lubricating oil dilution ratio DR refers to a value indicating how much the lubricating oil in crankcase 42 is diluted with unburned fuel mixed in the lubricating oil. A greater lubricating oil dilution ratio DR indicates more unburned fuel mixed in the lubricating oil.

Electronic control unit 13 estimates the lubricating oil dilution ratio DR based on, for example, the discharge pressure of an oil pump that circulates the lubricating oil. Internal combustion engine 1 includes the oil pump (not shown) for pumping the lubricating oil from the inside of crankcase 42 to several components of internal combustion engine 1. Specifically, electronic control unit 13 estimates the lubricating oil dilution ratio DR, based on the ratio of the pressure of the lubricating oil at the end of the previous engine operation to the reference pressure of the lubricating oil. As used herein, the reference pressure of the lubricating oil refers to a pressure at which lubricating oil non-contaminated with unburned fuel is pumped by the oil pump.

The greater the dilution ratio of the lubricating oil, that is, the more unburned fuel mixed in the lubricating oil, the lower the viscosity of the lubricating oil and the lower the discharge pressure of the oil pump . By leveraging this relationship, electronic control unit 13 sets the lubricating oil dilution ratio DR to a greater value as a greater pressure drop from the reference pressure of the lubricating oil is observed at the end of the previous engine operation. Here, when the lubricating oil has a greater lubricating oil dilution ratio DR, more fuel will be vaporized from the lubricating oil, and thus a greater amount of fuel will be returned by blow-by gas recirculation device 41 and will remain in the intake system while internal combustion engine 1 stops operation.

Having determined the lubricating oil dilution ratio DR, electronic control unit 13 then determines in step S102 whether the cooling water has been circulated by cooling system 51 while internal combustion engine 1 has stopped operation immediately before the current engine start-up; in other words, whether electric water pump 58 has been in operation during the previous stop of internal combustion engine 1. For example, when the current operation of internal combustion engine 1 is initiated by engine restart from idle reduction, and electric water pump 58 has been actuated and the cooling water has been circulated during this idle reduction, the operation proceeds to step 5103. On the other hand, when the current operation of internal combustion engine 1 is started by the vehicle driver's operation of the engine switch, and electric water pump 58 has not been actuated during the previous stop of internal combustion engine 1, the operation proceeds to step S104.

In step 103 or 104, electronic control unit 13 calculates an initial value of a downward correction ratio RQ (0≤RQ≤1.0). As used herein, the downward correction ratio RQ refers to a value indicating how much the additional fuel amount defined by the upward correction value Kst is reduced; thus, how much the fuel injection amount increased based on the upward correction value Kst is reduced. The downward correction ratio RQ is a correction term for the amount of fuel to be injected from fuel injection valves 5, and is used to reduce the fuel injection amount by an amount of fuel that has been returned into the intake system by blow-by gas recirculation device 41 (through blow-by gas recirculation passage 43) and remains in the intake system while internal combustion engine 1 has stopped.

The downward correction ratio RQ with a greater value causes a greater reduction in the additional fuel amount defined by the upward correction value Kst, and thus, causes a greater reduction in the amount of fuel to be injected from fuel injection valves 5. When the downward correction ratio RQ is set to 1.0 (RQ=1.0, the maximum value), the additional fuel amount defined by the upward correction value Kst is corrected to zero. When the downward correction ratio RQ is set to 0 (RQ=0, the minimum value), no reduction is caused in the additional fuel amount defined by the upward correction value Kst.

As will be described later, electronic control unit 13 gradually decreases the downward correction ratio RQ stepwise for each combustion cycle, thereby gradually decreasing a reduction in the additional fuel amount defined by the upward correction value Kst. The initial value of the downward correction ratio RQ refers to a value to which the downward correction ratio RQ, which is decreased gradually, is set initially. Within the engine start-up period, the initial value of the downward correction ratio RQ causes the greatest reduction in the additional fuel amount defined by the upward correction value Kst. As will be described in detail later, the downward correction of the upward correction value Kst using the downward correction ratio RQ is implemented by determining the upward correction value Kst using the formula Kst=Kstb×(1−RQ×RR), where Kstb is a base value of the upward correction value Kst, and RR (0≤RR≤1.0) is a reduction ratio of the downward correction ratio RQ used to gradually decrease the downward correction ratio RQ stepwise for each combustion cycle.

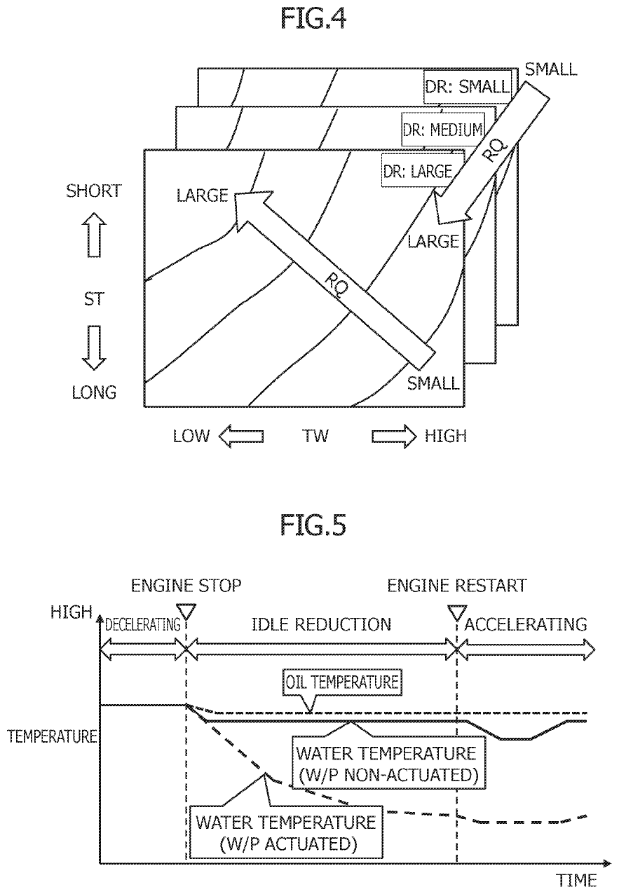

In step S103, electronic control unit 13 determines the initial value of the downward correction ratio RQ based on the lubricating oil dilution ratio DR, the non-operation time ST (duration for which internal combustion engine 1 stops operation) of internal combustion engine 1, and the water temperature TW at the engine start-up. Here, electronic control unit 13 has different initial value maps as shown, for example, in FIG. 4. Each map specifies the distribution of the initial value of the downward correction ratio RQ that varies depending on the length of the non-operation time ST of internal combustion engine 1 and depending on the water temperature TW at the start-up of internal combustion engine 1. The different initial value maps are prepared for different ranges of the lubricating oil dilution ratio DR. Thus, in step S103, electronic control unit 13 selects one of the initial value maps, based on the lubricating oil dilution ratio DR, and uses the selected map to determine the initial value associated with the length of the non-operation time ST and the water temperature TW that match their respective values for the current start-up of internal combustion engine 1. However, the way to determine the initial value of the downward correction ratio RQ is not limited to selection using one or more maps. As an alternative, electronic control unit 13 may determine the initial value of the downward correction ratio RQ by using a function of variables representing the lubricating oil dilution ratio DR, the non-operation time ST of internal combustion engine 1, the water temperature TW at the start-up of internal combustion engine 1.

Specifically, the water temperature TW at the engine start-up is higher and as the lubricating oil dilution ratio DR is smaller, electronic control unit 13 sets the initial value of the downward correction ratio RQ to a smaller value. That is, as the water temperature TW at the engine start-up is higher, electronic control unit 13 decreases a reduction in the additional fuel amount for during engine start-up; thus, decreases a reduction in the fuel supply during the engine start-up. Furthermore, as the lubricating oil dilution ratio DR is smaller, electronic control unit 13 decreases a reduction in the additional fuel amount for during engine start-up. Stated differently, as the water temperature TW at the engine start-up is lower, electronic control unit 13 increases a reduction in the additional fuel amount for during engine start-up. Furthermore, as the lubricating oil dilution ratio DR is greater, electronic control unit 13 increases a reduction in the additional fuel amount for during engine start-up.

Here, the level of unburned fuel returned by blow-by gas recirculation device 41 and remaining in the intake system while internal combustion engine 1 stops operation may be referred to as “engine-remaining fuel level”. The above control is based on the presumption that the lower the water temperature TW and/or the greater the lubricating oil dilution ratio DR, the higher the engine-remaining fuel level. However, if the cooling water is circulated while internal combustion engine 1 stops operation, using the water temperature TW at the subsequent engine start-up to estimate the engine-remaining fuel level will provide an inaccurate estimate, resulting in less accurate fuel reduction control based on engine-remaining fuel.

In summary, when cooling water circulation is stopped while internal combustion engine 1 stops operation, the deviation of the water temperature TW from the lubricating oil temperature is sufficiently small at the subsequent engine start-up, and thus, the engine-remaining fuel level, which actually depends on the temperature of the lubricating oil, can be estimated with sufficient accuracy based on the water temperature TW at the engine start-up. On the other hand, when electric water pump 58 is actuated and the cooling water is circulated while internal combustion engine 1 stops operation, such as during engine stop due to idle reduction, the deviation between the water temperature TW and the lubricating oil temperature will be increased and will reach a significant level at the subsequent engine restart. As such, in this case, the estimation of the engine-remaining fuel level based on the water temperature TW at the engine start-up will provide a less accurate estimate. As a result, electronic control unit 13 will fail to set the initial value of the downward correction ratio RQ (subtractive fuel amount) to an appropriate value.

FIG. 5 illustrates how the water temperature TW and the lubricating oil temperature behave during and around idle reduction. Specifically, FIG. 5 illustrates temperature behaviors during and around idle reduction performed while electric water pump 58 is actuated and the cooling water is circulated, and temperature behaviors during and around idle reduction performed with the same conditions excepting that electric water pump 58 is not actuated and the cooling water circulation continued to be stopped.

As shown in FIG. 5, when the cooling water circulation is stopped during idle reduction of internal combustion engine 1, the water temperature TW and the lubricating oil temperature change in a similar manner and are maintained substantially equal to each other over time. On the other hand, when the cooling water is circulated during idle reduction of internal combustion engine 1, the water temperature TW decreases at a rate greater than that of the lubricating oil temperature, and the cooling water temperature becomes significantly lower than the lubricating oil temperature at the subsequent restart of internal combustion engine 1. Thus, if the cooling water is circulated during idle reduction, and electronic control unit 13 then establishes the initial value of the downward correction ratio RQ based on the water temperature TW at the subsequent engine restart, the fuel supply will be excessively reduced and may provide an excessively lean air-fuel ratio. Such a too lean air-fuel ratio may lead to poor starting performance and/or detrimental exhaust characteristics at the start-up of internal combustion engine 1.

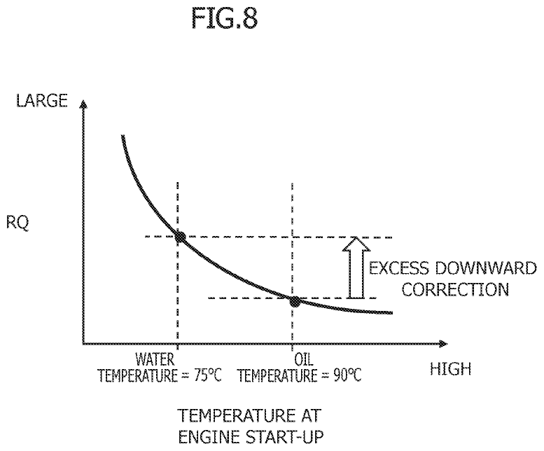

FIG. 8 illustrates an example of characteristics for establishing the initial value of the downward correction ratio RQ to be otherwise applied in an example case in which the cooling water is circulated during idle reduction of internal combustion engine 1, and the water temperature TW and the lubricating oil temperature are 75° C. and 90° C., respectively, at the subsequent engine restart. In this case, the lubricating oil temperature of 90° C. does correlate with an actual engine-remaining fuel level. Thus, if the downward correction ratio RQ is set based on the water temperature TW of 75° C., which is lower than the lubricating oil temperature, the fuel supply will be excessively reduced. Specifically, the excess reduction in this case corresponds to the difference between the downward correction ratios RQ90 and RQ75, where the downward correction ratios RQ adapted to 90° C. and 75° C. are indicated by RQ90 and RQ75, respectively (RQ75>RQ90).

Here, when the cooling water is circulated while internal combustion engine 1 stops operation, the deviation between the water temperature TW and the lubricating oil temperature increases with an increase in the non-operation time ST of internal combustion engine 1; i.e., with an increase in duration of cooling water circulation performed with the engine stopped. Thus, the longer the non-operation time ST, the greater the downward deviation of the water temperature TW from the lubricating oil temperature at the subsequent engine restart. As such, if the cooling water is circulated while internal combustion engine 1 stops operation, and electronic control unit 13 then establishes the initial value of the downward correction ratio RQ based on the water temperature TW at the subsequent engine restart, fuel supply may be reduced by an amount adapted to a higher-than-actual engine-remaining fuel level, and may result in excessive fuel supply reduction.

Thus, when the cooling water is circulated while internal combustion engine 1 stops operation, electronic control unit 13 sets the initial value of the downward correction ratio RQ based on the water temperature TW at the subsequent engine restart to a lower value as the non-operation time ST of internal combustion engine 1 is longer. This allows the initial value of the downward correction ratio RQ to be set to an appropriate value based on the water temperature TW, even when the cooling water is circulated during the previous stop of internal combustion engine 1, and thus, prevents excessive downward correction which may cause an excessive lean shift of the air-fuel ratio.

On the other hand, when the cooling water circulation is stopped while internal combustion engine 1 stops operation, the deviation between the water temperature TW and the lubricating oil temperature will be sufficiently small at the subsequent engine restart. As such, in step S104, electronic control unit 13 establishes the initial value of the downward correction ratio RQ based on the water temperature TW at the engine restart and the lubricating oil dilution ratio DR. Specifically, in step S104, electronic control unit 13 refers to a map as shown, for example, in FIG. 7 to determine the initial value of the downward correction ratio RQ associated with the water temperature TW and the lubricating oil dilution ratio DR that match their respective values for the current engine restart.

The characteristics for establishing the initial value of the downward correction ratio RQ depending on the varying water temperature TW and the characteristics for establishing the initial value of the downward correction ratio RQ depending on the varying lubricating oil dilution ratio DR in step S104 are the same as the corresponding characteristics for establishing the initial value in step S103. However, assuming the water temperature TW and the lubricating oil dilution ratio DR are equal, the initial value of the downward correction ratio RQ established in step S103 will be less than the initial value of the downward correction ratio RQ established in step S104, since step S104 involves the correction based on the non-operation time ST.

In summary, electronic control unit 13 calculates the initial value of the downward correction ratio RQ based on the water temperature TW and the lubricating oil dilution ratio DR. Furthermore, when the cooling water has been circulated by electric water pump 58 while internal combustion engine 1 stops operation, electronic control unit 13 downwardly corrects this initial value of the downward correction ratio RQ calculated based on the water temperature TW and the lubricating oil dilution ratio DR by an amount that increases as the non-operation time ST increases. On the other hand, when the cooling water circulation has been stopped while internal combustion engine 1 stops operation, electronic control unit 13 uses the uncorrected initial value of the downward correction ratio RQ that is calculated based on the water temperature TW and the lubricating oil dilution ratio DR to correct the upward correction value Kst. Alternatively, however, when the cooling water has been circulated by electric water pump 58 while internal combustion engine 1 stops operation, electronic control unit 13 may use a constant correction ratio to downwardly correct the initial value of the downward correction ratio RQ that is calculated based on the water temperature TW and the lubricating oil dilution ratio DR.

When electronic control unit 13 establishes the initial value of the downward correction ratio RQ in step S103 or S104, the operation proceeds to step S105. In step S105, electronic control unit 13 determines whether it is currently performing engine-starting fuel injection control. Specifically, when electronic control unit 13 determines that internal combustion engine 1 has started but the engine rotation speed has not yet reached a speed threshold for determining the completion of engine start-up, electronic control unit 13 determines that it is currently performing engine-starting fuel injection control, and the operation proceeds to step S106 and subsequent steps. On the other hand, when electronic control unit 13 determines that it is not currently performing engine-starting fuel injection control, it is not necessary to perform fuel reduction control for reducing the injection amount from fuel injection valves 5 in accordance with fuel remaining in the intake system, and thus, the operation returns to step S101.

When electronic control unit 13 determines that it is currently performing engine-starting fuel injection control, electronic control unit 13 counts the number of combustion cycles CIN accumulated from the onset of the current engine start-up in the subsequent step S106. Then, in step S107, electronic control unit 13 determines the reduction ratio RR for gradually decreasing the downward correction ratio RQ stepwise for each combustion cycle based on the accumulated number CIN of combustion cycles.

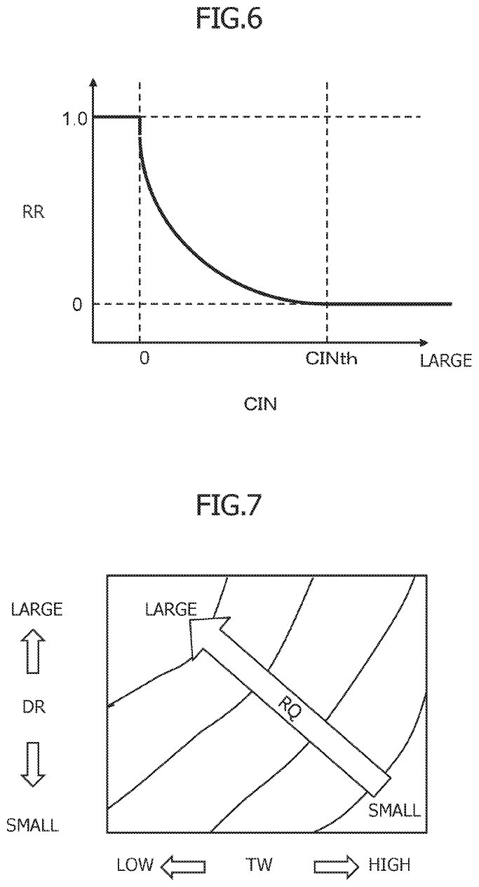

FIG. 6 illustrates a correlation example between the reduction ratio RR and the accumulated number CIN of combustion cycles. The reduction ratio RR has changing characteristics relative to the accumulated number CIN as shown in FIG. 6. Specifically, the reduction ratio RR is set to 1.0 when the accumulated number CIN of combustion cycles is zero; i.e., when internal combustion engine 1 is in the first combustion cycle. Then, the reduction ratio RR is gradually decreased as the accumulated number CIN increases and is set to zero when the accumulated number CIN reaches a threshold value CINth.

When the reduction ratio RR is set to 1.0, no downward correction is made to the initial value of the downward correction ratio RQ established in step S103 or S104, and thus, this uncorrected initial value is used as the downward correction value for the upward correction value Kst. When the reduction ratio RR is set to zero, the initial value of the downward correction ratio RQ established in step S103 or S104 is decreased to zero, and the fuel reduction control using the downward correction ratio RQ ends. After that, the upward correction value Kst without downward correction will be used to upwardly correct the fuel supply.

Here, the threshold value CINth for the accumulated number CIN, which defines when the reduction ratio RR should reach zero through gradual decrease, is set based on the number of combustion cycles required to be accumulated in order for combustion chambers 10 of the cylinders to draw, from the intake passages between electronically controlled throttle 8 and intake valves 19, the air with a volume corresponding to the entire volume of the intake passages. In other words, even if any unburned fuel remains in the intake passages at the engine start-up, combustion chambers 10 of the cylinders will have drawn, from the intake passages between electronically controlled throttle 8 and intake valves 19, substantially all of such engine-remaining fuel until the number of combustion cycles accumulated from the onset of the engine start-up reaches the threshold value CINth.

As a result, no unburned fuel will remain in the intake passages between electronically controlled throttle 8 and intake valves 19. In such a situation, the upward correction amount based on the upward correction value Kst does not have to be reduced anymore. That is, any unburned fuel remaining in the intake passages is expected to be scavenged away when the accumulated number CIN of combustion cycles reaches the threshold value CINth. Thus, rather than waiting for the completion of the engine start-up, when determining that the accumulated number CIN has reached the threshold value CINth, electronic control unit 13 ends the fuel reduction control for reducing the injection amount based on the downward correction ratio RQ and for thus preventing an excessive rich shift of the air-fuel ratio, which may be otherwise caused by engine-remaining fuel.

Here, the threshold value CINth is defined to satisfy Vol≤CINth×ED/NC, where

Vol is the volume of each of the intake passages between electronically controlled throttle 8 and intake valves 19, ED is the total amount of exhaust gas discharged from internal combustion engine 1, and NC is the total number of cylinders. Alternatively, however, electronic control unit 13 may end the fuel reduction control for reducing the injection amount based on the downward correction ratio RQ at an earlier timing, i.e., before combustion chambers 10 of the cylinders have completely drawn, from the intake passages between electronically controlled throttle 8 and intake valves 19, the air with a volume corresponding to the entire volume of the intake passages. Specifically, electronic control unit 13 may end the fuel reduction control at such an earlier timing of when the accumulated number CIN of combustion cycles reaches a value presumed to be sufficient to ensure that the fuel reduction control continued until the accumulated number CIN reaches this value will reliably prevent an excessive rich shift of the air-fuel ratio.

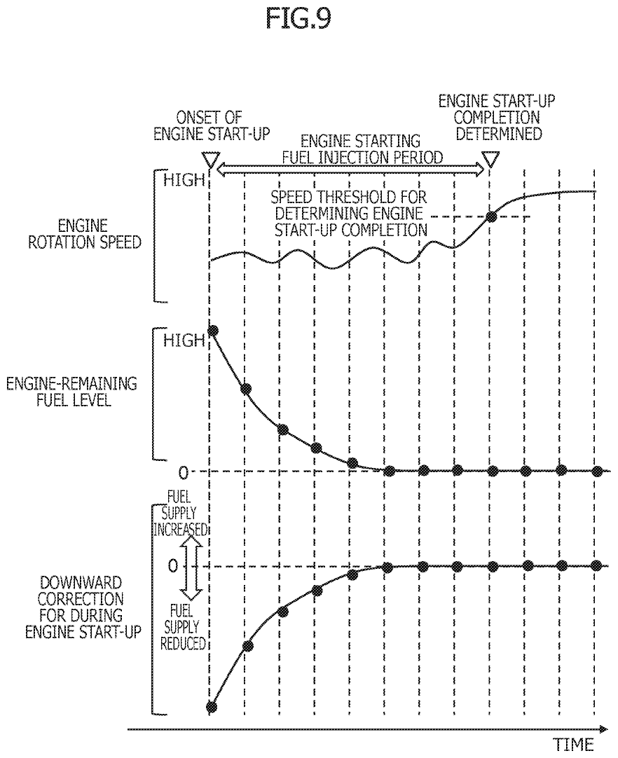

Furthermore, electronic control unit 13 may gradually diminish the reduction ratio RR at a decelerated rate, rather than a constant rate, as the accumulated number CIN of combustion cycles increases. Such a characteristic of the diminishing of the reduction ratio RR is adapted to how the volume of air newly introduced into the intake passages between electronically controlled throttle 8 and intake valves 19 increases and the engine-remaining fuel level decreases as the accumulated number CIN increases (see FIG. 9). As an alternative, however, electronic control unit 13 may diminish the reduction ratio RR at a constant rate as the accumulated number CIN increases.

After electronic control unit 13 sets the reduction ratio RR based on the accumulated number CIN, the operation proceeds to step S108. In step S108, electronic control unit 13 calculates the upward correction value Kst using Kst=Kstb×(1−RQ×RR). Then, electronic control unit 13 calculates the fuel injection pulse width TI by upwardly correcting, with this upward correction value Kst, the base fuel injection pulse width TP that is proportional to the base fuel injection amount corresponding to the target air-fuel ratio (TI=TP×Kstb). Electronic control unit 13 then outputs an injection pulse signal having the fuel injection pulse width TI to fuel injection valve 5 of each cylinder at an injection timing set for the cylinder, thereby causing each fuel injection valve 5 to inject fuel in an amount proportional to the fuel injection pulse width TI.

In step S109, electronic control unit 13 determines whether the accumulated number CIN of combustion cycles reaches the threshold value CINth. When electronic control unit 13 determines that the accumulated number CIN of combustion cycles is below the threshold value CINth, the operation returns to step S106, thereby continuing the gradual diminishing of the reduction ratio RR and the fuel reduction control for reducing the upward correction value Kst based on this gradually diminished reduction ratio RR and the initial value of the downward correction ratio RQ.

When electronic control unit 13 determines that the accumulated number CIN of combustion cycles reaches the threshold value CINth; i.e., CIN=CINth holds, the fuel reduction control for reducing the upward correction value Kst (for reducing the fuel supply) based on the downward correction ratio RQ ends. However, the reduction ratio RR may be diminished to zero before the accumulated number CIN reaches the threshold value CINth, and may be maintained at zero after that. In this case, the fuel reduction control for reducing the injection amount based on the downward correction ratio RQ practically ends when the reduction ratio RR reaches zero.

As described above, electronic control unit 13 performs the fuel reduction control for reducing the injection amount based on the downward correction ratio RQ so as to prevent an excessive rich shift of the air-fuel ratio, which may be otherwise caused by unburned fuel remaining in the intake passages, and ends this fuel reduction control at a time presumed to coincide with a time when combustion chambers 10 draws away substantially the entire volume of unburned fuel remaining in the intake passages; i.e., when the scavenging of engine-remaining fuel is completed (see FIG. 9). This prevents electronic control unit 13 from continuing the engine-starting fuel reduction control even after unburned fuel no longer remains in the intake passages. As such, excessive downward correction to the fuel injection amount is avoided, and improved starting performance and/or improved exhaust characteristics will be achieved during the start-up of internal combustion engine 1.

Furthermore, as shown in FIG. 9, electronic control unit 13 gradually decreases the subtractive fuel amount, which is defined by the downward correction ratio RQ, to be applied to the fuel injection amount, in accordance with a decrease in the level of unburned fuel remaining in the intake passages. Thus, electronic control unit 13 is able to control the air-fuel ratio highly accurately over the entire period of performing the fuel reduction control. As such, electronic control unit 13 is able to prevent an excessive rich shift of the air-fuel ratio, which may be otherwise caused by unburned fuel remaining in the intake passages, and also to avoid excessive downward correction based on the downward correction ratio RQ which may cause an excessive lean shift of the air-fuel ratio.

Furthermore, in establishing the initial value of the downward correction ratio RQ based on the water temperature TW at the engine start-up, electronic control unit 13 varies the initial value of the downward correction ratio RQ depending on whether the cooling water has been circulated during the previous stop of internal combustion engine 1. Here, at the restart of internal combustion engine 1 following idle reduction operation performed with the cooling water circulated, the water temperature TW will be deviated from the lubricating oil temperature, which does correlate with the level of unburned fuel remaining in the intake passages, for example. Even in such a case, the variability, as described above, of the initial value allows electronic control unit 13 to use the water temperature TW at the engine start-up to establish the initial value of the downward correction ratio RQ while avoiding excessive downward correction which may cause an excessive lean shift of the air-fuel ratio. In other words, electronic control unit 13 may be applied to internal combustion engine 1 that does not include any sensor for measuring the temperature of the lubricating oil and that does include idle reduction capability and/or another functionality that causes cooling water circulation while internal combustion engine 1 stops operation, and furthermore, electronic control unit 13 is able to perform air-fuel ratio control of such internal combustion engine 1 with a reliability comparable to air-fuel ratio control involving a fuel reduction control based on a measurement of the lubricating oil temperature.

### Second Embodiment

In the first embodiment above, electronic control unit 13 uses the water temperature TW at the engine start-up to determine the downward correction ratio RQ. Alternatively, electronic control unit 13 may use an oil temperature TO in place of the water temperature TW to determine the downward correction ratio RQ. As used herein, the oil temperature TO refers to the temperature of the lubricating oil of internal combustion engine 1.

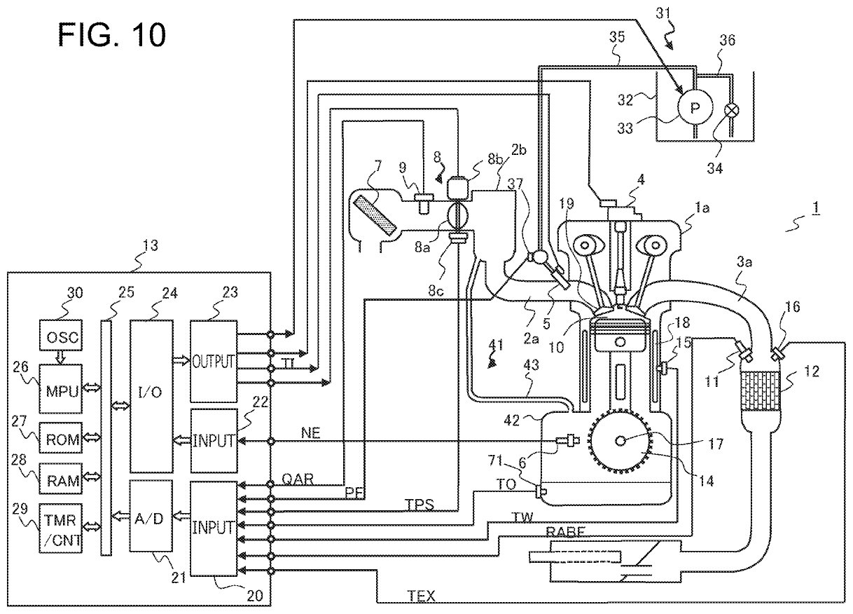

To allow the use of the oil temperature TO to determine the downward correction ratio RQ, internal combustion engine 1 to which the second embodiment is applied includes an oil temperature sensor 71 for measuring the oil temperature TO of internal combustion engine 1, as shown in FIG. 10. Internal combustion engine 1 shown in FIG. 10 has the same configuration as internal combustion engine 1 shown in FIG. 1, except that internal combustion engine 1 shown in FIG. 10 includes an oil temperature sensor 71. Note that identical or similar elements are denoted by the same reference numerals and will not be described in further detail below.

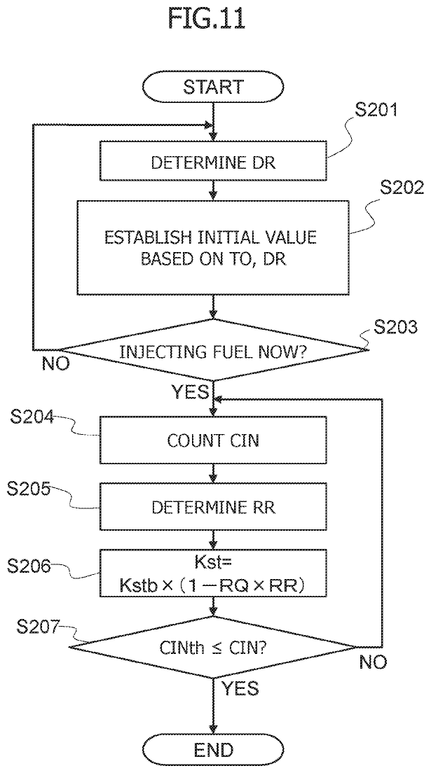

FIG. 11 is a flowchart illustrating a procedure of fuel reduction control which uses the downward correction ratio RQ determined based on the oil temperature TO. In step S201, electronic control unit 13 determines the lubricating oil dilution ratio DR as in step S101.

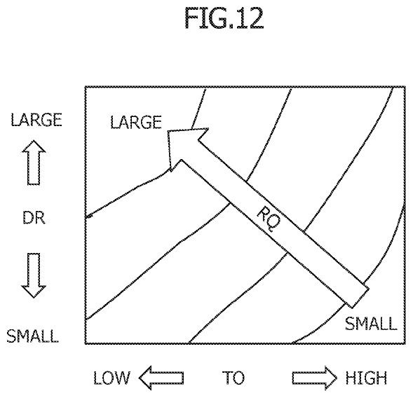

In the subsequent step S202, electronic control unit 13 determines the initial value of the downward correction ratio RQ based on the oil temperature TO at the start-up of internal combustion engine 1 and the lubricating oil dilution ratio DR. Specifically, as shown in FIG. 12, as the oil temperature TO at the engine start-up is lower and as the lubricating oil dilution ratio DR is greater, electronic control unit 13 sets the initial value of the downward correction ratio RQ to a greater value so as to reduce the fuel supply by a greater amount.

The above control is based on the presumption that as the oil temperature TO is lower and as the lubricating oil dilution ratio DR is greater, the level of unburned fuel remaining in the intake passages has increased to be higher while internal combustion engine 1 has stopped. Note that electronic control unit 13 establishes the initial value of the downward correction ratio RQ in step S202 without depending on whether the cooling water has been circulated during the previous stop of internal combustion engine 1. In other words, assuming the oil temperature TO and the lubricating oil dilution ratio DR are the same values, the initial value of the downward correction ratio RQ is set to the same value regardless of whether the cooling water has been circulated during the previous engine stop.

This is because when the cooling water is circulated while internal combustion engine 1 stops operation, the deviation between the water temperature TW and the oil temperature TO will be increased and will reach a significant level at the subsequent engine start-up. However, the level of unburned fuel remaining in the intake passages varies depending on the oil temperature TO more than the water temperature TW. As such, the accuracy of the fuel reduction control based on the oil temperature TO will not be significantly affected by whether the cooling water has been circulated during the previous stop of internal combustion engine 1.

When electronic control unit 13 establishes the initial value of the downward correction ratio RQ in step S202, the operation proceeds to step S203. In step S203, by determining whether internal combustion engine 1 has started and is rotating at an engine rotation speed that is below the speed threshold for determining the completion of engine start-up, electronic control unit 13 determines whether it is currently performing engine-starting fuel injection control, as in step S105. When electronic control unit 13 determines that it is currently performing engine-starting fuel injection control, the operation proceeds to step S204 and subsequent steps. The processing in steps S204 to S207 is the same as that in steps S106 to S109, and will not be described in further detail below.

According to the second embodiment above, electronic control unit 13 is prevented from continuing the engine-starting fuel reduction control even after unburned fuel no longer remains in the intake passages, and thus, excessive downward correction to the fuel injection amount is avoided, as in the first embodiment. Furthermore, the fuel reduction control is performed appropriately in accordance with a decrease in the level of unburned fuel remaining in the intake passages, as in the first embodiment. In addition, according to the second embodiment, downward correction to the fuel injection amount is performed in accordance with the level of unburned fuel remaining in the intake passages, with no need to take into account whether the current start-up of internal combustion engine 1 is the restart following idle reduction operation performed with the cooling water circulated. This simplifies adaptation for any specific application of the correction processing and also reduces the computational load therefor.

Although specific embodiments of the present invention have been described, it should be understood that the present invention is not limited to these but may include various modifications. The above embodiments include details that are only intended to clearly illustrate the present invention. Thus, the present invention is not necessarily limited to embodiments having all the features described herein, for example. Furthermore, one or more features of an embodiment herein may be replaced with corresponding features of another embodiment. Also, an embodiment herein may further include one or more features of another embodiment, and one or more features of an embodiment herein may be omitted.

For example, in the first embodiment, when the cooling water has been circulated while internal combustion engine 1 stops operation, electronic control unit 13 sets the subtractive fuel amount based on the water temperature TW at the subsequent engine restart to a lower value as the non-operation time ST of internal combustion engine 1 is longer. Similar control may also be applied to end time control for the fuel reduction control based on the accumulated number CIN of combustion cycles as well as to the fuel reduction control that does not use the reduction ratio RR to gradually decrease the downward correction ratio RQ. In other words, for the entire time from the onset to the determined completion of the engine start-up, electronic control unit 13 may use a fixed subtractive fuel amount that is set based on the water temperature TW at the engine start-up and the non-operation time ST.

### REFERENCE SYMBOL LIST

1 Internal combustion engine

2a Intake pipe

5 Fuel injection valve

8 Electronically controlled throttle

13 Electronic control unit

19 Intake valve

41 Blow-by gas recirculation device

51 Cooling system

58 Electric water pump

1. A fuel injection control device for an internal combustion engine including a blow-by gas recirculation device configured to return blow-by gas into an intake passage,
wherein the fuel injection control device is configured to:
determine a dilution ratio which indicates how much lubricating oil of the internal combustion engine is diluted with unburned fuel mixed in the lubricating oil; and
perform fuel reduction control for reducing fuel supply to the internal combustion engine by a subtractive fuel amount depending on the dilution ratio, in a period from an onset of start-up of the internal combustion engine to when a number of combustion cycles accumulated from the onset of the engine start-up reaches a threshold value.

2. The fuel injection control device for an internal combustion engine, according to claim 1,
wherein, in the fuel reduction control, the subtractive fuel amount to be applied to the fuel supply is decreased as the accumulated number increases.

3. The fuel injection control device for an internal combustion engine, according to claim 1,
wherein, in the fuel reduction control, the subtractive fuel amount to be applied to the fuel supply is modified depending on the dilution ratio and a temperature of cooling water for the internal combustion engine.

4. The fuel injection control device for an internal combustion engine, according to claim 1,
wherein, in the fuel reduction control, the subtractive fuel amount to be applied to the fuel supply is modified depending on the dilution ratio and depending on whether the cooling water is circulated through the internal combustion engine during a previous stop of the internal combustion engine.

5. The fuel injection control device for an internal combustion engine, according to claim 4,
wherein, when the cooling water is circulated through the internal combustion engine during the previous stop of the internal combustion engine, the subtractive fuel amount to be applied to the fuel supply is modified depending on the dilution ratio and a duration of the previous stop of the internal combustion engine, in the fuel reduction control.

6. The fuel injection control device for an internal combustion engine, according to claim 1,
wherein, in the fuel reduction control, the subtractive fuel amount to be applied to the fuel supply is set to a greater value as the dilution ratio is greater.

7. The fuel injection control device for an internal combustion engine, according to claim 3,
wherein, in the fuel reduction control, the subtractive fuel amount to be applied to the fuel supply is set to a greater value as the dilution ratio is greater and as the temperature of the cooling water for the internal combustion engine is higher.

8. The fuel injection control device for an internal combustion engine, according to claim 4,
wherein, in the fuel reduction control, the subtractive fuel amount to be applied to the fuel supply is set to a value which is greater as the dilution ratio is greater, and which is greater when the cooling water is circulated through the internal combustion engine during the previous stop of the internal combustion engine than when the cooling water is not circulated through the internal combustion engine during the previous stop of the internal combustion engine.

9. The fuel injection control device for an internal combustion engine, according to claim 5,
wherein, when the cooling water is circulated through the internal combustion engine during the previous stop of the internal combustion engine, the subtractive fuel amount to be applied to the fuel supply is set to a value which is greater as the dilution ratio is greater, and which is smaller as the duration for which the internal combustion engine stops operation is longer, in the fuel reduction control.

10. The fuel injection control device for an internal combustion engine, according to claim 1,
wherein, in the fuel reduction control, the subtractive fuel amount to be applied to the fuel supply is modified depending on the dilution ratio and a temperature of the lubricating oil.

11. The fuel injection control device for an internal combustion engine, according to claim 10,
wherein, in the fuel reduction control, the subtractive fuel amount to be applied to the fuel supply is set to a greater value as the dilution ratio is greater and as the temperature of the lubricating oil of the internal combustion engine is lower.

12. A fuel injection control method for an internal combustion engine including a blow-by gas recirculation device configured to return blow-by gas into an intake passage, the method comprising:
determining a dilution ratio which indicates how much lubricating oil of the internal combustion engine is diluted with unburned fuel mixed in the lubricating oil;
determining, based on the dilution ratio, an initial value of a downward correction ratio for correcting fuel supply to the internal combustion engine;
gradually decreasing the downward correction ratio from the initial value as a number of combustion cycles accumulated from an onset of start-up of the internal combustion engine increases; and
reducing the fuel supply to the internal combustion engine based on the downward correction ratio in a period from the onset of start-up of the internal combustion engine to when the accumulated number of combustion cycles reaches a threshold value.
